(19) United States
(12) Patent Application Publication
(10) Pub. No.: US 2018/0098284 A1
(43) Pub. Date: Apr. 5, 2018

(54) PROXIMITY-BASED RADIO ADVERTISING ACTIVATION

(71) Applicant: McAfee, Inc., Santa Clara, CA (US)

(72) Inventors: Glen J. Anderson, Beaverton, OR (US); John Teddy, Beaverton, OR (US); Chakradhar Kotamraju, Beaverton, OR (US)

(21) Appl. No.: 15/281,778

(22) Filed: Sep. 30, 2016

(51) Int. Cl. H04W 52/02; H04W 76/02; H04W 4/00; H04W 48/10

(52) U.S. Cl. CPC H04W 52/0229; H04W 48/10; H04W 4/008; H04W 76/023

(57) ABSTRACT

Pairing two devices includes detecting, by a first device, a trigger event that indicates that a second device is within a predetermined proximity, obtaining a first time stamp indicating a time of the trigger event as recorded by the first device, determining whether a difference between the first time stamp and a second time stamp satisfy a predetermine threshold, where the second time stamp indicates a time of the trigger event as recorded by the second device, and in response to determining that the difference between the first time stamp and the second time stamp satisfies the predetermined threshold, allowing the first device to pair with the second device.

### TECHNICAL FIELD

Embodiments described herein generally relate to wireless connectivity, and more specifically to proximity-based radio advertising activation.

### BACKGROUND ART

Today's technology allows users to connect any number of computer devices. Such devices may include, for example, personal computers, laptops, television devices, cell phones, tablets, smart watches, and other devices. In addition, the rise of Internet of Things (IoT) devices allows for the connection of a number of devices not typically considered computing devices, such as medical devices, children's toys, home appliances, wearable devices, and any number of other items that may contain some kind of data activity.

One of the benefits of computing devices is the ability to wirelessly connect multiple devices to share data or functionality. As an example, one device may have a camera to capture images or video, and another device may include a display. By connecting the two devices, image data captured on the first device may be displayed on the second device. However, there are some drawbacks to current methods of pairing such devices. For example, in the case of IoT devices, often the device should have a low-power mode. The ability to connect wirelessly to other devices may require more power than would be ideal. Further, network-capable devices often collect a massive amount of data, some of which may be personal data. Allowing a device to be constantly transmitting a pairing signal may cause security issues for the data. Thus, what is needed is a low-power method for providing wireless connectivity among devices.

### BRIEF DESCRIPTION OF DRAWINGS

FIG. 1 is a diagram illustrating a network of programmable devices according to one or more embodiments.

FIG. 2 is a diagram illustrating an example system for proximity-based radio advertising activation according to one or more embodiments.

FIG. 3 is a diagram illustrating for a pair of devices capable of proximity-based radio advertising activation according to one or more embodiments.

FIG. 4 is a flow diagram illustrating a technique for proximity-based radio advertising activation, according to one or more embodiments.

FIG. 5 is a diagram illustrating a computing device for use with techniques described herein according to one embodiment.

FIG. 6 is a block diagram illustrating a computing device for use with techniques described herein according to another embodiment.

### DESCRIPTION OF EMBODIMENTS

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

As used herein, the term “programmable device” can refer to a single programmable device or a plurality of programmable devices working together to perform the function described as being performed on or by the programmable device.

As used herein, the term “medium” refers to a single physical medium or a plurality of media that together store what is described as being stored on the medium.

As used herein, the term “network device” can refer to any programmable device that is capable of communicating with another programmable device across any type of network.

In one or more embodiments, a technique is provided for connecting two or more programmable devices in a secure manner. Specifically, in one or more embodiments, a low- or unpowered switch is triggered indicating than two devices are within a short distance. The trigger may indicate, for example, that the two devices are within a predetermined proximity. In one or more embodiments, the switch may be triggered during a locking event, or other event, in which the two devices are coupled. In one or more embodiments, the trigger event may cause a time stamp to be captured at each device. Each device may collect their own time stamp and obtain a time stamp from the other device. Based on a comparison of the two time stamps, each device may determine whether to trigger the pairing process. In one or more embodiments, the recognition of the trigger event, along with a determination that the two time stamps are within a particular time period, may be sufficient to determine that the two devices are allowed to be paired. For example, if the two devices are connectable by Bluetooth®, the devices may only be discoverable to each other for a short period of time after the trigger event and the time period are confirmed. (BLUETOOTH is a registered trademark of Bluetooth Special Interest Group.)

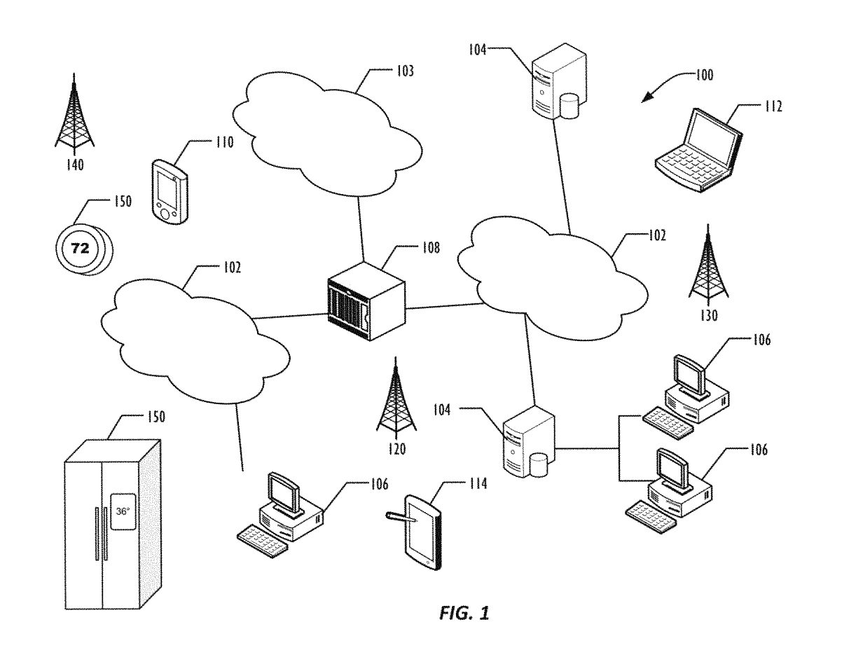

FIG. 1 also includes internet of things (IoT) devices 150. IoT devices may be non-traditional computing devices that have less resources than traditional computing devices. IoT devices typically have a memory and some processing power. Often, IoT devices include sensors that are used to gather data and transmit data to a host device, such as a traditional computing device. The functionality of an IoT device may be specific, and may be used in conjunction with functionality of additional devices to which the IoT device connects. IoT devices may include any number of devices, such as smart watches, thermostats, refrigerators, wearable devices, cameras, medical devices, and any number of other types of devices which include programmable components and network connectivity. IoT devices 150 may include network connectivity that allows the devices to connect to other devices over different types of computer networks available today, such as the Internet, a corporate network, a Local Area Network (LAN), or a personal network, such as those over a Bluetooth connection.

Referring to the figures, FIG. 1 an example infrastructure 100 in which embodiments may be implemented is illustrated schematically. Infrastructure 100 contains computer networks 102. Computer networks 102 may include many different types of computer networks available today, such as the Internet, a corporate network, a Local Area Network (LAN), or a personal network, such as those over a Bluetooth connection. Each of these networks can contain wired or wireless programmable devices and operate using any number of network protocols (e.g., TCP/IP). Networks 102 may be connected to gateways and routers (represented by 108), end user computers 106, and computer servers 104. Infrastructure 100 also includes cellular network 103 for use with mobile communication devices. Mobile cellular networks support mobile phones and many other types of mobile devices. Mobile devices in the infrastructure 100 are illustrated as mobile phones 110, laptops 112, and tablets 114. A mobile device such as mobile phone 110 may interact with one or more mobile provider networks as the mobile device moves, typically interacting with a plurality of mobile network towers 120, 130, and 140 for connecting to the cellular network 103. Each of the networks 102 may contain a number of other devices typically referred to as Internet of Things (microcontrollers, embedded systems, industrial control computing modules, etc.). Although referred to as a cellular network in FIG. 1, a mobile device may interact with towers of more than one provider network, as well as with multiple non-cellular devices such as wireless access points and routers 108. In addition, the mobile devices 110, 112, and 114 may interact with non-mobile devices such as computers 104 and 106 for desired services. The functionality of the gateway device 108 may be implemented in any device or combination of devices illustrated in FIG. 1; however, most commonly is implemented in a firewall or intrusion protection system in a gateway or router.

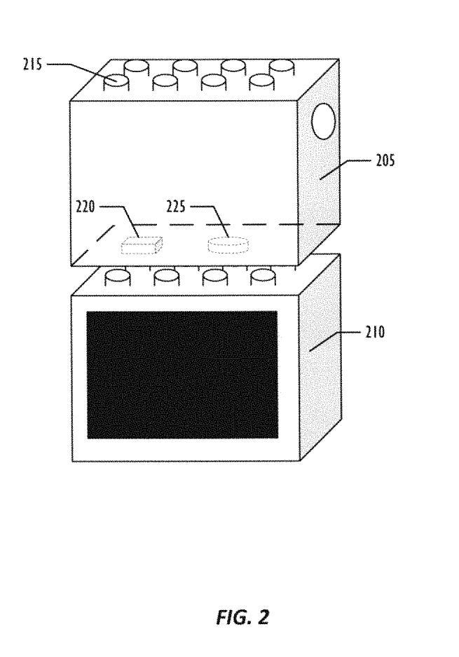

FIG. 2 is a diagram illustrating an example diagram of a system for proximity-based radio advertising activation according to one or more embodiments. FIG. 2 includes two programmable devices, device A 205 and device B 210. In one or more embodiments, device A 205 and device B 210 may be communicably connected such that data and/or functionality may be shared between the two. In one or more embodiments, device A 205 and device B 210 may also be physically coupled together. The detection of physical coupling, or close proximity, may trigger a pairing process between the two devices that allows the devices to be operatively coupled.

In one or more embodiments, device A 205 and device B 210 may be physically coupled using a physical coupling mechanism, such as the extrusions shown at 215. According to one or more embodiments, the extrusions may facilitate in the physical connection of device A 205 and device B 210 by providing a locking or engagement mechanism. Further, in one or more embodiments, the connection between device A and device B may be facilitated using other components, such as a magnet 225, instead of or in addition to the physical coupling mechanism. In one or more embodiments, the engagement of the magnet may be sufficient to determine that device A 205 and device B 210 are coupled. For example, detection of the magnetic fields of the other device may indicate that the two devices are sufficiently close to one another, even if other coupling mechanisms are not engaged. However, in one or more embodiments, the magnet and the physical coupling mechanism may both need to be engaged. For example, the magnet may be coupled to the coupling mechanism or trigger activation of the physical coupling mechanism.

In one or more embodiments, the extrusion, or physical coupling mechanism, may include or be connected to a switch 220. In one or more embodiments, the switch 220 may be a low-powered or unpowered switch. The switch 220 may be triggered when device A 205 is within a predetermined proximity of device B 210. In one or more embodiments, the switch 220 may be triggered in response to an activation of the magnet 225, or the physical coupling of device A 205 and device B 210. For example, the switch may be activated by a locking event between the coupling mechanism 215 of device A 205 and a receiving portion on a surface of device B 210. The switch 220 may be, for example, a Reed switch.

In one or more embodiments, the activation of the switch 220 may trigger an activation of a radio that allows device A 205 to pair with device B 210. For example, activation of the switch 220 may trigger an activation of a Bluetooth radio such that device A 205 and device B 210 may be paired. Thus, in one or more embodiments, device A 205 may not transmit a pairing signal until the switch 220 is triggered. In one or more embodiments, the activation switch may trigger the activation of any kind of wireless radio, such as ANT or Zigbee. (ANT is a registered trademark of Garmin Ltd. and ZIGBEE is a registered trademark of Zigbee Alliance.)

In one or more embodiments, device A 205 and device B 210 may each include a switch 220 that is activated when device A 205 and device B 210 are within a particular proximity of each other. Further, in one or more embodiments, each of device A 205 and device B 210 may include a clock. A time stamp may be generated by each device at the time of triggering the switch 220, and used to determine whether the proximity of the two devices triggered the switch. As an example, device A 205 may detect the trigger of switch 220, and generate a time stamp indicating when the switch was triggered. Device A 205 may receive a time stamp from device B 210, indicating a time at which a switch in device B 210 was triggered. Device A 205 may compare the locally-generated timestamp with the timestamp received from device B 210 to determine if the switches were triggered by the presence of the other device. If the time stamps are within a particular time span, then each device may transmit data required for pairing. In one or more embodiments, the timestamps must be recorded within a predetermined amount of time in order to satisfy a threshold. If device A 205 determines that a difference between the timestamps satisfy a predetermined threshold, then device A 205 may transmit pairing data, and receive pairing data from device B 210. Then, data may be transferred between device A 205 and device B 210. Satisfying the predetermined threshold may involve any function that compares the difference between the timestamps with the predetermined threshold.

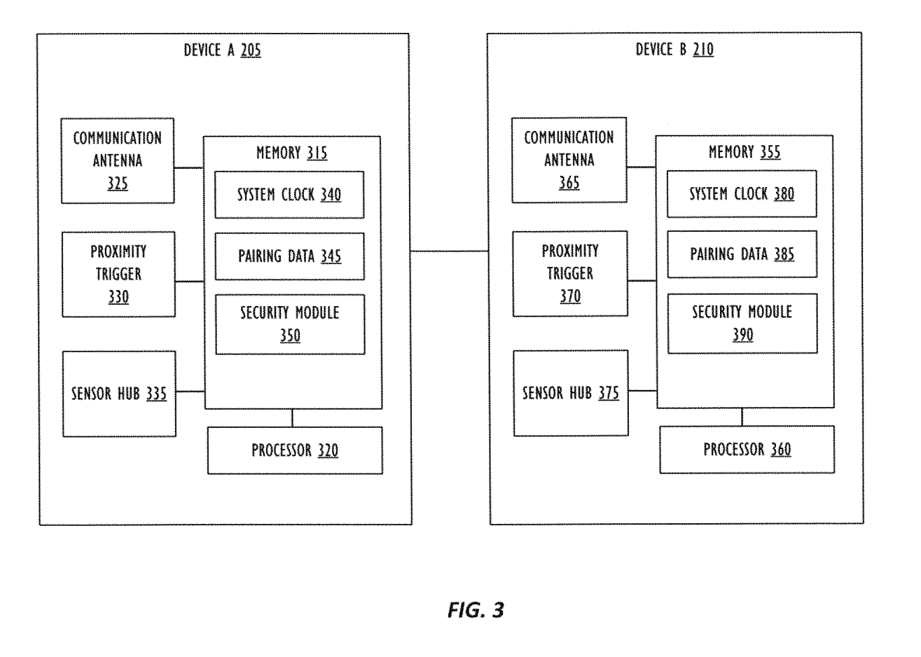

FIG. 3 is a diagram illustrating a system diagram for proximity-based radio advertising activation according to one or more embodiments. In one or more embodiments, the system diagram shows various modules and components of device A 205 and device B 210.

Device A 205 may include, for example, a memory 315 and processor 320. Memory 315 may include a number of software or firmware modules executable by processor 320. In one or more embodiments, memory 315 may include a security module 350. In one or more embodiments, security module 350 ensures that device A 205 transmits pairing data 345 in a limited and secure manner. For example, security module 350 may only allow the transmission of the pairing data 345 if it is determined that device A 205 is within a sufficient proximity to device B 210.

In one or more embodiments, security module 350 may use a number of factors to determine whether device B 210 is within a sufficient proximity to device A 205. According to one or more embodiments, security module 350 may receive data from sensor hub 335 to determine whether device B 210 is within a close proximity to device A 205. As an example, sensor hub 335 may include powered- and unpowered-sensors.

In one or more embodiments, security module 350 may additionally, or alternatively, rely on data received from a proximity trigger 330. As an example, the proximity trigger 330 may be a low-power or unpowered switch, such as a Reed switch, or a magnetic switch. The proximity trigger 330 may be triggered in response to device A 205 and device B 210 being within close proximity. That is, the proximity trigger 330 may be triggered upon device B 210 being within such a close proximity to device A 205 as to activate the proximity trigger 330. In one or more embodiments, the proximity trigger 330 may be triggered when device A 205 is coupled to device B 210. For example, in one or more embodiments, device A 205 and device B 210 may have coupling mechanisms that are configured to interlock with each other, and the interlocking of the coupling mechanism may trigger the proximity trigger 330.

In one or more embodiments, the security module 350 may allow for the wireless connection of device A 205 and device B 210 in response to the activation of the proximity trigger 330. In one or more embodiments, the security module 350 may rely on additional, or alternative, data or events prior to allowing for the wireless connection of device A 205 and device B 210. Specifically, in one or more embodiments, the security module 350 may ensure that the trigger event also triggered proximity trigger 370 in device B 210. In one or more embodiments, security module 350 may determine whether the same trigger event triggered proximity trigger 330 and proximity trigger 370 using time stamps. That is, in one or more embodiments, security module 350 may obtain a time stamp indicating a time that the proximity trigger 330 was activated. For example, a time stamp may be obtained using a system clock 340 of device A 340. Further, security module 350 may compare the time stamp generated by device A 205 with a time stamp received from device B 210, indicating a time at which the proximity trigger 370 was activated. Likewise, in one or more embodiments, security module 350 may transmit the time stamp generated by device A 205, indicating a time the activation of proximity trigger 330 is recorded, to device B 210. In one or more embodiments, the time stamp may be transmitted by communication antenna 325. As an example, each of device A 205 and device B 210 may synchronize their system clocks 340 and 380 with each other. In one or more embodiments, system clock 340 and system clock 380 may be synchronized with an external device, such as a host device connected to device A 205 and device B 210 over a network. A host device may be any computing device, such as those described above with respect to FIG. 1.

In one or more embodiments, if the two time stamps indicate that the proximity triggers 330 and 370 were activated within a short period of time, then the security module 350 may allow device A 205 to connect to device B 210. Thus, in one or more embodiments, the level of security is increased by only allowing connectivity if the two devices are in a close proximity, physically abutted, or connected. In one or more embodiments, security module 350 may allow device A 205 to connect to device B 210 by transmitting pairing data 345 for device B 210. In one or more embodiments, pairing data 345 can include a device identification and other data utilized for connecting the devices. For example, the pairing data 345 may include data transmitted by the communication antenna 325 to pair the two devices in a Bluetooth connection.

In one or more embodiments, the two time stamps must satisfy a predetermined threshold in order to determine that the same trigger event was detected in both devices. The predetermined threshold may be specific to a particular device involved in the pairing, or to the combination of devices involved in the pairing. Further, according to one or more embodiments, the predetermined threshold may be set by a user. As an example, one or both of device A 205 and device B 210 may include a user interface, such as a graphical user interface, by which a user may enter a selected predetermined threshold. According to alternate embodiments, a host device operably connectable to one or both of device A 205 and device B 210 may provide a user interface, such as a graphical user interface, by which a user may select or otherwise indicate a predetermined threshold.

Similar to device A 205, device B has a processor 360 and memory 355, which may include a system clock 380, pairing data 385, and security module 390. Memory 355 may additionally include computer readable instructions executable by processor 360 in the form of system clock 380, pairing data 385, and security module 390. Device B 210 may also include an antenna 365 and sensor hub 375. In one or more embodiments, the various components of device B 210 may be similar to the functionality of the corresponding components in device A 205.

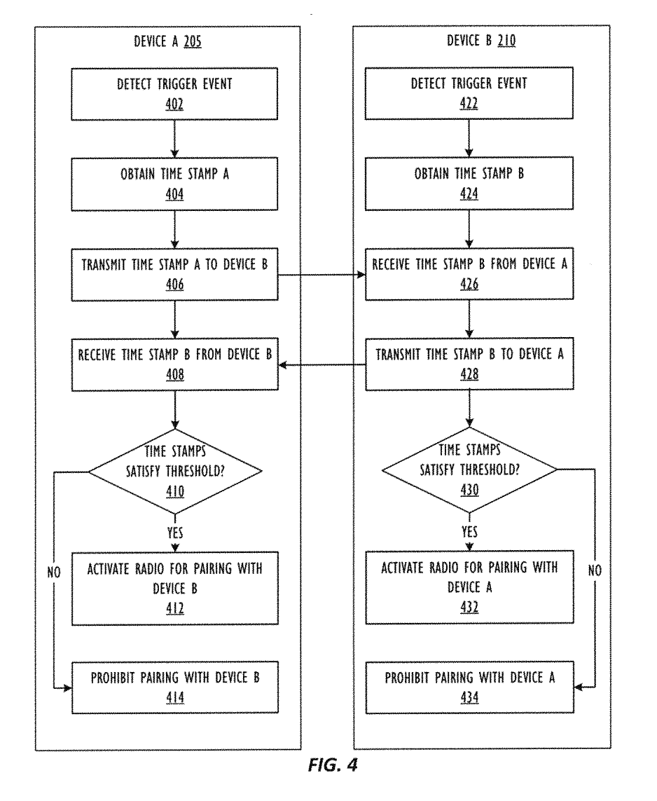

FIG. 4 is a flow diagram illustrating a technique for proximity-based radio advertising activation, according to one or more embodiments. FIG. 4 illustrates a method occurring between device A 205 and device B 210. In one or more embodiments, device A 205 and device B 210 may be operatively connectable to each other over a Bluetooth or similar wireless connection. Although the various steps in FIG. 4 are shown in a particular order, in one or more embodiments, the various activity depicted may be in another order. Further, various actions may be removed, or additional actions may be added. Moreover, in one or more embodiments, two or more of the actions depicted by occur in parallel. For purposes of clarity, the various actions will be discussed by referring back to various components as described in FIG. 3. However, in one or more embodiments, the various actions may be taken by alternative components, or components not discussed in FIG. 3.

The method begins at 402 and a trigger event is detected. In one or more embodiments, a trigger event may occur when a trigger is activated. For example, in one or more embodiments, a trigger event may be an activation of proximity trigger 330, which may be, for example, a switch. According to one or more embodiments, one or both of device A 205 and device B 210 may be in an unpowered state prior to the detected trigger event. Further, the trigger event may cause one or both of device A 205 and device B 210 to become powered on from an unpowered state.

The method continues at 404 and the security module 350 obtains a time stamp A. As described above, security module 350 may obtain the time stamp A from system clock 340. The time stamp A may indicate a time as recorded by system clock 340 at which a trigger event was detected. The flow diagram continues at 406, and device A 205 transmits the time tamp to device B 210. In one or more embodiments, the transmission of the time stamp may occur prior to a pairing action. The time stamp may be transmitted along with other handshake data, such as a device identification or authentication tokens. As an example, the timestamp may be transmitted with initial data that indicates the identity of device A 205 such that device B 210 may determine that device A 205 is whitelisted.

The method continues at 408, and device A 205 receives a time stamp B from device B 210. According to one or more embodiments, the time stamp B may be transmitted along with identification data identifying that it was generated by device B 210, or other data. According to one or more embodiments, time stamp B may indicate a time at which a trigger event was detected by device B 210. The method continues at 410 and a determination is made whether the time stamps satisfy a predetermined threshold. In one or more embodiments, time stamp A and time stamp B may be compared to determine whether they were captured as recording the same trigger event. That is, if the two time stamps record the same or similar time, they are determined to be likely have been recorded in response to the same trigger event, such as device A 205 interlocking or abutting with device B 210. Thus, in one or more embodiments, the predetermined threshold may be used to determine whether the time stamps are within a predetermined period of time. According to one or more embodiments, the predetermined threshold may be a default time period within which two different time stamps may be considered as associated with the same trigger event. In alternate embodiments of the invention, the predetermined threshold may be determined based on characteristics of device A 205 and/or device B 210. As an example, the identification data transmitted along with time stamp B at 408 may indicate to device A 205 one or more characteristics of device B 210. In one or more embodiments, the predetermined threshold may be based on the characteristics of one or more of the devices. As an example, certain characteristics of device B 210 may indicate that it takes longer to record a time stamp than device A 205. Device A 205 may similarly transmit characteristics or other information indicative of a predetermined threshold that should be used in association with device A 205.

If it is determined at 410 that time stamp A and time stamp B satisfies a threshold, then the method continues at 412 and a radio is activated for pairing device A 205 with device B 210. In one or more embodiments, activating a radio for pairing may include transmitting pairing data such that device A 205 may pair with device B 210.

Returning to 410, if it is determined that time stamp A and time stamp B do not satisfy the threshold, then the method continues at 414 and device A 205 is prohibited from pairing with device B 210. For example, in one or more embodiments, device A 205 may not transmit pairing data if the threshold is not satisfied. As another example, device A 205 may determine not to pair with device B 210 even if pairing data from device B 210 is received. Thus, in one or more embodiments, device A 205 and device B 210 are paired in response to a combination of a detection of a trigger event, and the confirmation that the other device also detected a trigger event at or near the same time. The pairing data may be any type of pairing data that may be defined by whatever pairing protocol is used by the devices 205 and 210.

Further, because the trigger event may be detected by both device A 205 and device B 210, similar actions as those that occur in 402-414 in device A 205 may also occur in device B 210. The method in device B 210 may begin at 422 when a trigger event is detected. In one or more embodiments, the trigger event detected in 422 is a same event or corresponding event as that detected in 402. For example, if device A 205 and device B 210 are placed within a predetermined proximity, or are interlocked or otherwise coupled, proximity trigger 330 and proximity trigger 370 may each be activated.

The method continues at 424 and device B 210 obtains time stamp B. As described above, time stamp B may indicate a time at which device B 210 recognizes the trigger event detected at 422. In one or more embodiments, time stamp B may be obtained from system clock 380. In one or more embodiments, device B 210 receives time stamp A from device A 205 at 426, and at 428, transmits time stamp B to device A 205. Thus, at 430, device B 210 may compare time stamp A and time stamp B to determine whether time stamp A and time stamp B satisfy a threshold at 430. Similar to 412 and 414, if device B 210 determines that time stamp A and time stamp B satisfies a threshold, then the method continues at 432, and device B 210 activates a radio for pairing with device A 205. If device B 210 determines that time stamp A and time stamp B do not satisfy a threshold, then the method continues at 434 and device B 210 prohibits pairing with device A 205.

In one or more embodiments, device A 205 may be considered a parent device and device B 210 may be considered a child device. Thus, device A 205 may require the time stamp from device B 210 in order to provide pairing information, while device B 210 may freely provide pairing information to device A 205 without requiring any additional data.

In one or more embodiments, once device A 205 and device B 210 are connected, a third device may be connected to the network. In one or more embodiments, the third device may be allowed to pair with device A 205 and device B 210 when the third device is within a predetermined proximity. In one or more embodiments, the predetermined proximity for connecting the third device may be different than the predetermined proximity used to connect device A 205 and device B 210. Further, in one or more embodiments, the third device may also generate a time stamp, and the threshold for allowing pairing of the third device to device A 205 and device B 210 may be the same as the threshold used in 410 and 430.

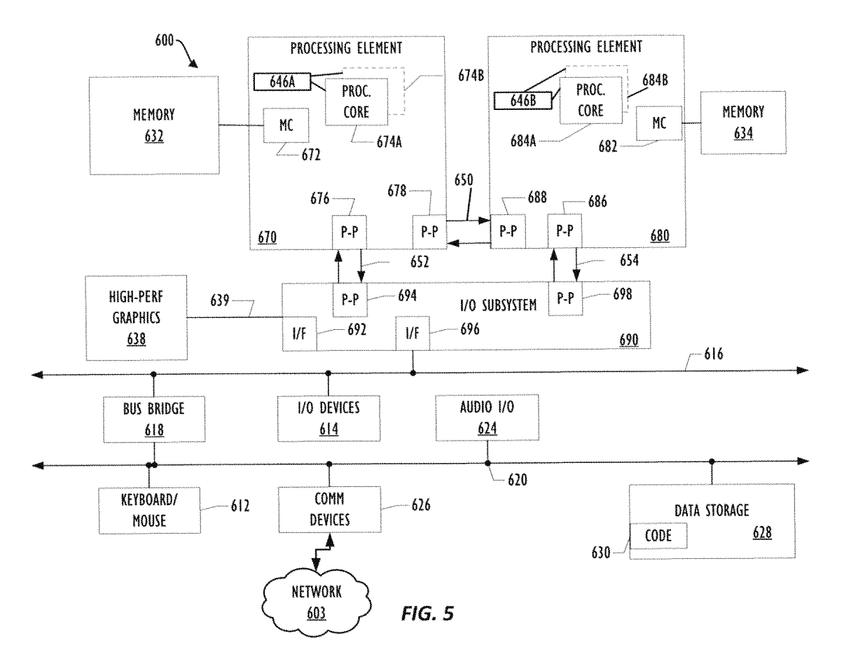

Referring now to FIG. 5, a block diagram illustrates a programmable device 600 that may be used within an IoT device, such as device 205, or device 210, in accordance with one or more embodiments. Devices 205 and 210 may not include all of the elements of FIG. 5. The programmable device 600 illustrated in FIG. 5 is a multiprocessor programmable device that includes a first processing element 670 and a second processing element 680. While two processing elements 670 and 680 are shown, an embodiment of programmable device 600 may also include only one such processing element.

Programmable device 600 is illustrated as a point-to-point interconnect system, in which the first processing element 670 and second processing element 680 are coupled via a point-to-point interconnect 650. Any or all of the interconnects illustrated in FIG. 5 may be implemented as a multi-drop bus rather than point-to-point interconnects.

As illustrated in FIG. 5, each of processing elements 670 and 680 may be multicore processors, including first and second processor cores (i.e., processor cores 674a and 674b and processor cores 684a and 684b). Such cores 674a, 674b, 684a, 684b may be configured to execute instruction code in a manner similar to that discussed above in connection with FIGS. 1-4. However, other embodiments may use processing elements that are single core processors as desired. In embodiments with multiple processing elements 670, 680, each processing element may be implemented with different numbers of cores as desired.

Each processing element 670, 680 may include at least one shared cache 646. The shared cache 646a, 646b may store data (e.g., instructions) that are utilized by one or more components of the processing element, such as the cores 674a, 674b and 684a, 684b, respectively. For example, the shared cache may locally cache data stored in a memory 632, 634 for faster access by components of the processing elements 670, 680. In one or more embodiments, the shared cache 646a, 646b may include one or more mid-level caches, such as level 2 (L2), level 3 (L3), level 4 (L4), or other levels of cache, a last level cache (LLC), or combinations thereof.

While FIG. 5 illustrates a programmable device with two processing elements 670, 680 for clarity of the drawing, the scope of the present invention is not so limited and any number of processing elements may be present. Alternatively, one or more of processing elements 670, 680 may be an element other than a processor, such as an graphics processing unit (GPU), a digital signal processing (DSP) unit, a field programmable gate array, or any other programmable processing element. Processing element 680 may be heterogeneous or asymmetric to processing element 670. There may be a variety of differences between processing elements 670, 680 in terms of a spectrum of metrics of merit including architectural, microarchitectural, thermal, power consumption characteristics, and the like. These differences may effectively manifest themselves as asymmetry and heterogeneity amongst processing elements 670, 680. In some embodiments, the various processing elements 670, 680 may reside in the same die package.

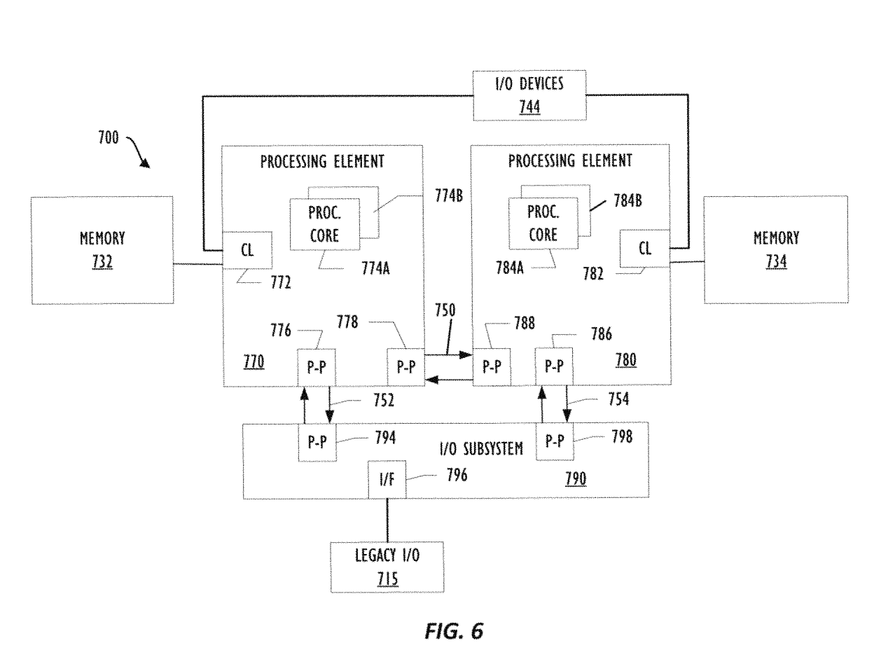

First processing element 670 may further include memory controller logic (MC) 672 and point-to-point (P-P) interconnects 676 and 678. Similarly, second processing element 680 may include a MC 682 and P-P interconnects 686 and 688. As illustrated in FIG. 6, MCs 672 and 682 couple processing elements 670, 680 to respective memories, namely a memory 632 and a memory 634, which may be portions of main memory locally attached to the respective processors. While MC logic 672 and 682 is illustrated as integrated into processing elements 670, 680, in some embodiments the memory controller logic may be discrete logic outside processing elements 670, 680 rather than integrated therein.

Processing element 670 and processing element 680 may be coupled to an I/O subsystem 690 via respective P-P interconnects 676 and 686 through links 652 and 654. As illustrated in FIG. 6, I/O subsystem 690 includes P-P interconnects 694 and 698. Furthermore, I/O subsystem 690 includes an interface 692 to couple I/O subsystem 690 with a high performance graphics engine 638. In one embodiment, a bus (not shown) may be used to couple graphics engine 638 to I/O subsystem 690. Alternately, a point-to-point interconnect 639 may couple these components.

In turn, I/O subsystem 690 may be coupled to a first link 616 via an interface 696. In one embodiment, first link 616 may be a Peripheral Component Interconnect (PCI) bus, or a bus such as a PCI Express bus or another I/O interconnect bus, although the scope of the present invention is not so limited.

As illustrated in FIG. 5, various I/O devices 614, 624 may be coupled to first link 616, along with a bridge 618 which may couple first link 616 to a second link 620. In one embodiment, second link 620 may be a low pin count (LPC) bus. Various devices may be coupled to second link 620 including, for example, a keyboard/mouse 612, communication device(s) 626 (which may in turn be in communication with the computer network 603), and a data storage unit 628 such as a disk drive or other mass storage device which may include code 630, in one embodiment. The code 630 may include instructions for performing embodiments of one or more of the techniques described above. Further, an audio I/O 624 may be coupled to second bus 620.

Note that other embodiments are contemplated. For example, instead of the point-to-point architecture of FIG. 5, a system may implement a multi-drop bus or another such communication topology. Although links 616 and 620 are illustrated as busses in FIG. 5, any desired type of link may be used. Also, the elements of FIG. 5 may alternatively be partitioned using more or fewer integrated chips than illustrated in FIG. 5.

Referring now to FIG. 6, a block diagram illustrates a programmable device 700 according to another embodiment. Certain aspects of FIG. 5 have been omitted from FIG. 6 in order to avoid obscuring other aspects of FIG. 6.

FIG. 6 illustrates that processing elements 770, 780 may include integrated memory and I/O control logic (“CL”) 772 and 782, respectively. In some embodiments, the 772, 782 may include memory control logic (MC) such as that described above in connection with FIG. 5. In addition, CL 772, 782 may also include I/O control logic. FIG. 6 illustrates that not only may the memories 732, 734 be coupled to the 772, 782, but also that I/O devices 744 may also be coupled to the control logic 772, 782. Legacy I/O devices 715 may be coupled to the I/O subsystem 790 by interface 796. Each processing element 770, 780 may include multiple processor cores, illustrated in FIG. 6 as processor cores 774A, 774B, 784A, and 784B. As illustrated in FIG. 6, I/O subsystem 790 includes P-P interconnects 794 and 798 that connect to P-P interconnects 776 and 786 of the processing elements 770 and 780 with links 752 and 754. Processing elements 770 and 780 may also be interconnected by link 750 and interconnects 778 and 788, respectively.

The programmable devices depicted in FIGS. 5 and 6 are schematic illustrations of embodiments of programmable devices which may be utilized to implement various embodiments discussed herein. Various components of the programmable devices depicted in FIGS. 6 and 7 may be combined in a system-on-a-chip (SoC) architecture.

It is to be understood that the various components of the flow diagrams described above, could occur in a different order or even concurrently. It should also be understood that various embodiments of the inventions may include all or just some of the components described above. Thus, the flow diagrams are provided for better understanding of the embodiments, but the specific ordering of the components of the flow diagrams are not intended to be limiting unless otherwise described so.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product that may include a machine readable medium having stored thereon instructions that may be used to program a processing system or other electronic device to perform the methods. The term “machine readable medium” used herein shall include any medium that is capable of storing or encoding a sequence of instructions for execution by the machine and that cause the machine to perform any one of the methods described herein. The term “machine readable medium” shall accordingly include, but not be limited to, tangible, non-transitory memories such as solid-state memories, optical and magnetic disks. Furthermore, it is common in the art to speak of software, in one form or another (e.g., program, procedure, process, application, module, logic, and so on) as taking an action or causing a result. Such expressions are merely a shorthand way of stating that the execution of the software by a processing system causes the processor to perform an action or produce a result.

The following examples pertain to further embodiments.

Example 1 is a machine readable medium on which instructions for proximity-based activation of a device are stored, comprising instructions that when executed cause one or more processors to: detect, by a first device, a trigger event that indicates that a second device is within a predetermined proximity; obtain a first time stamp indicating a time of the trigger event as recorded by the first device; determine whether a difference between the first time stamp and a second time stamp satisfies a predetermined threshold, wherein the second time stamp indicates a time of the trigger event as recorded by the second device; and in response to determining that the difference between the first time stamp and the second time stamp satisfies the predetermined threshold, allow the first device to pair with the second device.

Example 2 is the machine readable medium of claim 1, wherein the instructions to cause the one or more processors to detect the trigger event further comprise instructions to detect an activation of an unpowered switch in the first device.

Example 3 is the machine readable medium of claim 1, further comprising computer code to: obtain a characteristic of the second device; and determine the predetermined threshold based on the characteristic of the second device.

Example 4 is the machine readable medium of any of claims 1-2, wherein the instructions to allow the first device to pair with the second device comprises instructions to cause a radio to broadcast a pairing signal.

Example 5 is the machine readable medium of any of claims 1-2, wherein the trigger event comprises a physical connecting event between the first device and the second device.

Example 6 is the machine readable medium of any of claims 1-2, wherein the first device is powered on in response to the trigger event.

Example 7 is the machine readable medium of claim 6, wherein the physical connecting event triggers instructions to cause the one or more processors to: detect, by the first device, a second trigger event that indicates that a third device is within a second predetermined proximity; obtain a third time stamp indicating a time of the second trigger event as recorded by the first device; determine whether a difference between the third time stamp and a fourth time stamp satisfies a second predetermined threshold, wherein the fourth time stamp indicates a time of the second trigger event as recorded by the third device; and in response to determining that the difference between the third time stamp and the fourth time stamp satisfies the second predetermined threshold, allow the first device to pair with the third device.

Example 8 is a proximity-activated Internet of Things device, comprising: one or more processors; and a memory comprising instructions executable by the one or more processors to: detect, by a first device, a trigger event that indicates that a second device is within a predetermined proximity; obtain a first time stamp indicating a time of the trigger event as recorded by the first device; determine whether a difference between the first time stamp and a second time stamp satisfy a predetermine threshold, wherein the second time stamp indicates a time of the trigger event as recorded by the second device; and in response to determining that the difference between the first time stamp and the second time stamp satisfies the predetermined threshold, allow the first device to pair with the second device.

Example 9 is the system of claim 8, wherein the instructions to cause the system to detect the trigger event further comprises instructions to detect an activation of an unpowered switch in the first device.

Example 10 is the system of any of claims 8-9, wherein the instructions further comprise instructions to: obtain a characteristic of the second device; and determine the predetermined threshold based on the characteristic of the second device.

Example 11 is the system of any of claims 8-9, wherein the instructions to allow the first device to pair with the second device comprises instructions to cause a radio to broadcast a pairing signal.

Example 12 is the system of any of claims 8-9, wherein the trigger event comprises a physical connecting event between the first device and the second device.

Example 13 is the system of any of claims 8-9, wherein the first device is powered on in response to the trigger event.

Example 14 is the system of claim 13, wherein the physical connecting event comprises instructions to cause the one or more processors to: detect, by the first device, a second trigger event that indicates that a third device is within a second predetermined proximity; obtain a third time stamp indicating a time of the second trigger event as recorded by the first device; determine whether a difference between the third time stamp and a fourth time stamp satisfies a second predetermined threshold, wherein the fourth time stamp indicates a time of the second trigger event as recorded by the third device; and in response to determining that the difference between the third time stamp and the fourth time stamp satisfies the second predetermined threshold, allow the first device to pair with the third device.

Example 15 is a method for pairing proximity-activated devices, comprising: detecting, by a first device, a trigger event that indicates that a second device is within a predetermined proximity; obtaining a first time stamp indicating a time of the trigger event as recorded by the first device; determining whether a difference between the first time stamp and a second time stamp satisfies a predetermined threshold, wherein the second time stamp indicates a time of the trigger event as recorded by the second device; and in response to determining that the difference between the first time stamp and the second time stamp satisfies the predetermined threshold, allowing the first device to pair with the second device.

Example 16 is the method of claim 15, wherein detecting the trigger event further comprises detecting an activation of an unpowered switch in the first device.

Example 17 is the method of any of claims 15-16, further comprising: obtaining a characteristic of the second device; and determining the predetermined threshold based on the characteristic of the second device.

Example 18 is the method of any of claims 15-16, wherein allowing the first device to pair with the second device comprises causing a radio to broadcast a pairing signal.

Example 19 is the method of any of claims 15-16, wherein the trigger event comprises a physical connecting event between the first device and the second device.

Example 20 is the method of any of claims 15-16, further comprising powering on the first device in response to the trigger event.

Example 21 is the method of any of claims 15-16, further comprising: detecting, by the first device, a second trigger event that indicates that a third device is within a second predetermined proximity; obtaining a third time stamp indicating a time of the second trigger event as recorded by the first device; determining whether a difference between the third time stamp and a fourth time stamp satisfies a second predetermined threshold, wherein the fourth time stamp indicates a time of the second trigger event as recorded by the third device; and in response to determining that the difference between the third time stamp and the fourth time stamp satisfies the second predetermined threshold, allowing the first device and the second device to pair with the third device.

Example 22 is the method of claim 21, wherein the predetermined proximity and the second predetermined proximity are different.

Example 23 is the method of claim 21, wherein the predetermined threshold and the second predetermined threshold are different.

Example 24 is the method of claim 21, wherein the predetermined threshold is based on the combination of the first and second device, and wherein the second predetermined threshold is based on the combination of the third device and at least one of the first device and the second device.

Example 25 is the method of claim 21 wherein determining whether the difference between the third time stamp and the fourth time stamp satisfies the second predetermined threshold is performed differently than determining whether the difference between the first time stamp and the second time stamp satisfies the predetermined threshold.

Example 26 is an apparatus for proximity-based activation of a device, comprising: means for detecting, by a first device, a trigger event that indicates that a second device is within a predetermined proximity; means for obtaining a first time stamp indicating a time of the trigger event as recorded by the first device; means for determining whether a difference between the first time stamp and a second time stamp satisfies a predetermined threshold, wherein the second time stamp indicates a time of the trigger event as recorded by the second device; and means for, in response to determining that the difference between the first time stamp and the second time stamp satisfies the predetermined threshold, allowing the first device to pair with the second device.

Example 27 is the apparatus of claim 26, wherein the means for detecting the trigger event further comprises means for detecting an activation of an unpowered switch in the first device.

Example 28 is the apparatus of any of claims 26-27, further comprising: means for obtaining a characteristic of the second device; and means for determining the predetermined threshold based on the characteristic of the second device.

Example 29 is the apparatus of any of claims 26-27, wherein the means for allowing the first device to pair with the second device comprises means for causing a radio to broadcast a pairing signal.

Example 30 is the apparatus of any of claims 26-27, wherein the trigger event comprises a physical connecting event between the first device and the second device.

Example 31 is the apparatus of any of claims 26-27, wherein the first device is powered on in response to the trigger event.

Example 32 is the apparatus of claim 31, wherein the physical connecting event triggers: means for detecting, by the first device, a second trigger event that indicates that a third device is within a second predetermined proximity; means for obtaining a third time stamp indicating a time of the second trigger event as recorded by the first device; means for determining whether a difference between the third time stamp and a fourth time stamp satisfies a second predetermined threshold, wherein the fourth time stamp indicates a time of the second trigger event as recorded by the third device; and means for, in response to determining that the difference between the third time stamp and the fourth time stamp satisfies the second predetermined threshold, allowing the first device to pair with the third device.

It is to be understood that the above description is intended to be illustrative, and not restrictive. For example, the above-described embodiments may be used in combination with each other. As another example, the above-described flow diagrams include a series of actions which may not be performed in the particular order depicted in the drawings. Rather, the various actions may occur in a different order, or even simultaneously. Many other embodiment will be apparent to those of skill in the art upon reviewing the above description. The scope of the invention should therefore be determined with reference to the appended claims, along with the full scope of equivalents to which such claims are entitled.

What is claimed is:

1. A machine readable medium on which instructions for proximity-based activation of a device are stored, comprising instructions that when executed cause one or more processors to:
detect, by a first device, a trigger event that indicates that a second device is within a predetermined proximity;
obtain a first time stamp indicating a time of the trigger event as recorded by the first device;
determine whether a difference between the first time stamp and a second time stamp satisfies a predetermined threshold, wherein the second time stamp indicates a time of the trigger event as recorded by the second device; and
in response to determining that the difference between the first time stamp and the second time stamp satisfies the predetermined threshold, allow the first device to pair with the second device.

2. The machine readable medium of claim 1, wherein the instructions to cause the one or more processors to detect the trigger event further comprise instructions to detect an activation of an unpowered switch in the first device.

3. The machine readable medium of claim 1, further comprising computer code to:
obtain a characteristic of the second device; and
determine the predetermined threshold based on the characteristic of the second device.

4. The machine readable medium of claim 1, wherein the instructions to allow the first device to pair with the second device comprises instructions to cause a radio to broadcast a pairing signal.

5. The machine readable medium of claim 1, wherein the trigger event comprises a physical connecting event between the first device and the second device.

6. The machine readable medium of claim 1, wherein the first device is powered on in response to the trigger event.

7. The machine readable medium of claim 6, wherein the physical connecting event triggers instructions to cause the one or more processors to:
detect, by the first device, a second trigger event that indicates that a third device is within a second predetermined proximity;
obtain a third time stamp indicating a time of the second trigger event as recorded by the first device;
determine whether a difference between the third time stamp and a fourth time stamp satisfies a second predetermined threshold, wherein the fourth time stamp indicates a time of the second trigger event as recorded by the third device; and
in response to determining that the difference between the third time stamp and the fourth time stamp satisfies the second predetermined threshold, allow the first device to pair with the third device.

8. A proximity-activated Internet of Things device, comprising:
one or more processors; and
a memory comprising instructions executable by the one or more processors to:
detect, by a first device, a trigger event that indicates that a second device is within a predetermined proximity;
obtain a first time stamp indicating a time of the trigger event as recorded by the first device;
determine whether a difference between the first time stamp and a second time stamp satisfy a predetermine threshold, wherein the second time stamp indicates a time of the trigger event as recorded by the second device; and
in response to determining that the difference between the first time stamp and the second time stamp satisfies the predetermined threshold, allow the first device to pair with the second device.

9. The system of claim 8, wherein the instructions to cause the system to detect the trigger event further comprises instructions to detect an activation of an unpowered switch in the first device.

10. The system of claim 8, wherein the instructions further comprise instructions to:
obtain a characteristic of the second device; and
determine the predetermined threshold based on the characteristic of the second device.

11. The system of claim 8, wherein the instructions to allow the first device to pair with the second device comprises instructions to cause a radio to broadcast a pairing signal.

12. The system of claim 8, wherein the trigger event comprises a physical connecting event between the first device and the second device.

13. The system of claim 8, wherein the first device is powered on in response to the trigger event.

14. The system of claim 13, wherein the physical connecting event comprises instructions to cause the one or more processors to:
detect, by the first device, a second trigger event that indicates that a third device is within a second predetermined proximity;
obtain a third time stamp indicating a time of the second trigger event as recorded by the first device;
determine whether a difference between the third time stamp and a fourth time stamp satisfies a second predetermined threshold, wherein the fourth time stamp indicates a time of the second trigger event as recorded by the third device; and
in response to determining that the difference between the third time stamp and the fourth time stamp satisfies the second predetermined threshold, allow the first device to pair with the third device.

15. A method for pairing proximity-activated devices, comprising:
detecting, by a first device, a trigger event that indicates that a second device is within a predetermined proximity;
obtaining a first time stamp indicating a time of the trigger event as recorded by the first device;
determining whether a difference between the first time stamp and a second time stamp satisfies a predetermined threshold, wherein the second time stamp indicates a time of the trigger event as recorded by the second device; and
in response to determining that the difference between the first time stamp and the second time stamp satisfies the predetermined threshold, allowing the first device to pair with the second device.

16. The method of claim 15, wherein detecting the trigger event further comprises detecting an activation of an unpowered switch in the first device.

17. The method of claim 15, further comprising:
obtaining a characteristic of the second device; and
determining the predetermined threshold based on the characteristic of the second device

18. The method of claim 15, wherein allowing the first device to pair with the second device comprises causing a radio to broadcast a pairing signal.

19. The method of claim 15, wherein the trigger event comprises a physical connecting event between the first device and the second device.

20. The method of claim 15, further comprising powering on the first device in response to the trigger event.

21. The method of claim 15, further comprising:
detecting, by the first device, a second trigger event that indicates that a third device is within a second predetermined proximity;
obtaining a third time stamp indicating a time of the second trigger event as recorded by the first device;
determining whether a difference between the third time stamp and a fourth time stamp satisfies a second predetermined threshold, wherein the fourth time stamp indicates a time of the second trigger event as recorded by the third device; and
in response to determining that the difference between the third time stamp and the fourth time stamp satisfies the second predetermined threshold, allowing the first device and the second device to pair with the third device.

22. The method of claim 21, wherein the predetermined proximity and the second predetermined proximity are different.

23. The method of claim 21, wherein the predetermined threshold and the second predetermined threshold are different.

24. The method of claim 21, wherein the predetermined threshold is based on the combination of the first and second device, and wherein the second predetermined threshold is based on the combination of the third device and at least one of the first device and the second device.

25. The method of claim 21 wherein determining whether the difference between the third time stamp and the fourth time stamp satisfies the second predetermined threshold is performed differently than determining whether the difference between the first time stamp and the second time stamp satisfies the predetermined threshold.
